(19) United States
(12) Patent Application Publication
(10) Pub. No.: US 2002/0182959 A1
(43) Pub. Date: Dec. 5, 2002

(54) Fire-resistant and sound-isolating paneling system for ships internal areas lining

(76) Inventors: Galinos Nikolaidis, Markopoulo-Messogion (GR); Georges Stamoulis, Nea Kifisia (GR); Panagiotis Yannoulis, Maroussi (GR); Nikolaos Amiradakis, Markopoulo-Messogion (GR); Constantine Hassiotis, Filothei (GR)

Correspondence Address: LADAS & PARRY, 26 WEST 61ST STREET, NEW YORK, NY, 10023, US

(21) Appl. No.: 10/048,270

(22) PCT Filed: May 11, 2001
(86) PCT No.: PCT/GR01/00023

(30) Foreign Application Priority Data
Jun. 1, 2000 (GR) 20000100186

(51) Int. Cl. B32B 17/02; B32B 17/04

(52) U.S. Cl. 442/180

(57) ABSTRACT

The present patent concerns the construction of various types of paneling for the ships internal areas lining with layers of fire-resistant and sound-isolating materials, that hold in with multiple layers of Magnesium content. These non flammable isolating panels, when appropriately bound together, form a final complex construction, which is also non flammable, with strict specifications of sound-isolation, high strength in extreme strains and low weight. The following special characteristics constitute the originality of the patent: a) Chemical composition (components specific percentages/Absence of Sulfur Magnesia) and production mode of the binding material. b) Internal structure, connection and reinforcement of the paneling layers. c) Assembling methodology of these panels for the prefabrication, transportation and installation of various sections of the accommodation areas, so that, after their installation and modulation on the ships, they: 1) Meet the strict specifications of sound-isolation. 2) Meet the strict specifications of fire-resistance. 3) The strength of these materials as well as the strength of the formed areas, during the extreme strains of the ships in the sea under the most sever conditions, are ensured. 4) The weight reduction, in comparison with the conventional panels, is ensured.

### INTRODUCTION

The weight reduction of the materials, which are used for the construction of the ships accommodation areas, is more and more important for the weight reduction (transportation capability increase) and the satisfaction of the relative strict regulations for the modern passenger ships.

The use of prefabricated sections of the accommodation areas, so that the ships construction total time is reduced, is constantly increasing at today's extremely competitive environment of this industrial sector internationally.

The satisfaction of the more and more strict specifications of sound-isolation for the passengers' and crew's comfort, as well as the satisfaction of the more and more strict rules of the fire-resistance for the safety of the Life at Sea (SOLAS), is necessary.

### 1. GENERALLY

The present patent concerns the construction of various types of panels for the ships internal areas coating with layers of fire-resistant and sound-isolating materials, that hold in with multiple layers of Magnesium content.

The following especial characteristics constitute the originality of the patent:

a) Chemical composition (components specific percentages/Absence of Sulfur Magnesia) and production mode of the binding material.

b) Internal structure, connection and reinforcement of the panels layers.

c) Assembling methodology of these panels for the prefabrication, transportation and installation of various sections of the accommodation areas, so that, after their installation and modulation on the ships, they:

1) Meet the strict specifications of sound-isolation

2) Meet the strict specifications of fire-resistance

3) The strength of these materials as well as the strength of the formed areas, during the extreme strain of the ships in the sea under the most sever conditions, is ensured.

4) The weight reduction, in comparison with the conventional panels, is ensured.

### 2. VARIOUS PUBLICATIONS

a) The U.S. Pat. No. 3,098,062 refers to a lining type with layers, that consists of an internal inflexible element from metallic fibers and at least one surface layer of plaster. The fiber element is covered by a paper layer, which offers a nice surface for final sheathing (e.g. with color). The plaster's strength in fire is limited and the surface layer is soft and fragile.

b) The Belgian Publication Number 886.016 refers to a production method of a heat-insulating cast covering, which consists of magnesium oxide and magnesium chloride. This mixture can be combined with a kind of reinforcing material. More details on the application of this material, how the strength of the various constructions, where it is applied, is ensured, as well as the sound-isolation and the fire-resistance accomplished, is not mentioned.

c) The Patent Application Number WO 97/21884 refers to a lining panel that consists of one or two isolating layers.

The fire-resistant binding material contains:

magnesium chloride

magnesium sulfate (see the following page's lines 12-15)

magnesium oxide

sodium silicate

Other times the basic element of the fire-resistant material is described to be the magnesium chloride, at a percentage up to at least 47% and other times the basic element of the fire-resistant material of the lining panel is the magnesium oxide, at a percentage up to 48,3%.

The use of the magnesium sulfate has many problems when the panels happen to be in conditions of increased relative moisture, in combination with low environment temperatures, during the production, but also during the transportation and after the installation at the ship.

The internal reinforcements of the lining panels are constructed by the same binding material, resulting in noise transfer and in not meeting the strict sound-isolation specifications.

The Publication also refers, without details, only to one binding of floor and wall, resulting in not knowing the fire-resistance of a complete system, that is a complete construction, with linings, partition walls, ceilings and doors.

### 3. PATENT'S OBJECT

The object of the present patent is to give non-flammable insulation panel which when connected appropriately to each other, consist a complex final construction, also non-flammable, with strict sound-isolation specifications, high strength to extreme strain and low weight.

### 4. PATENT'S PURPOSE

The purpose of the patent is achieved, firstly wit the layering and the internal structure of the panels, combined with the connecting, the prefabrication, as well as the transportation and the installation of the final construction of the accommodation areas sections, such as side linings partition walls, ceilings, doors, complete cabins, sanitary areas.

### 5. LAYERING AND INTERNAL STRUCTURE OF PANELS

This is achieved through the installation of various layers of glass-cloth as a support, a layer or layers of mineral fiber as an insulating material and multiple layers of binding material, which contains magnesium oxide, magnesium chloride, sodium silicate in proper percentages, so that after the solidification, the desired strength to fire is succeeded.

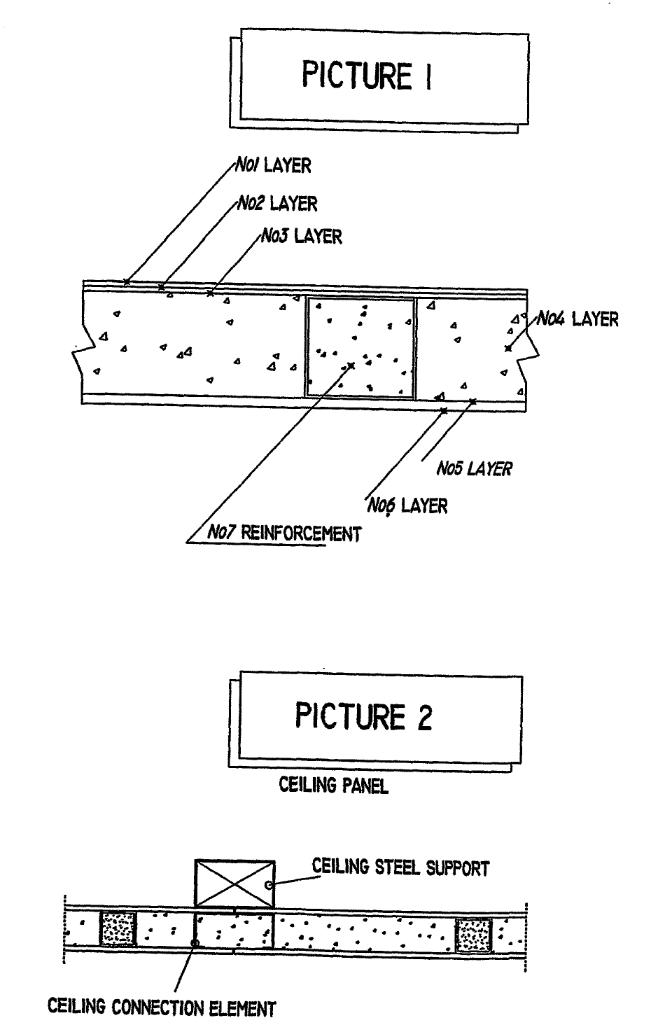

In FIG. 1, the multiple layering of a simple panel are shown. Layer 1 consists of a low density glass cloth, for the achievement of a perfectly smooth panel surface after the solidification and take out from the mold.

Layers 2 and 3 consist of a higher density glass cloth. Layer 4 consists of mineral fiber. Mineral fiber's strips are fitted alongside the small dimension of the panel. At certain distances, for the improvement of strength in compression and the satisfaction of strict sound insulation specifications, higher density strips of mineral fibers (7), immersed in and enriched with a binding material, are fitted in parallel with the high dimension of the panel and vertically to the surface level.

Layers 5 and 6 consist of glass cloth similar of the layers 2 and 3.

The described layers, combined with the multiple layers of binding material consist a system with excellent fire-resistant and sound-isolating result and a low weight.

### 6. COMPOSITION OF THE BINDING MATERIAL

Magnesium blent of MgO—MgCl₂ improved by the addition of sodium silicate is used as the binding structural material of the panels.

For the preparation of the binding material, the following raw materials are used:

1. Magnesia (MgO), of 91-95% purity.

2. Magnesium Chloride (MgCl₂), of 47% purity.

3. Sodium Silicate (SiO₂:Na₂O)

4. Water

The composition of the binding material during its application is the following:

| | |
|---|---|
| 1. Magnesia (MgO) | 33,33% |
| 2. Magnesium Chloride (MgCl₂) | 24,24% |
| 3. Water glass | 2,02% |
| 4. Water | 40,40% |

The Magnesium Oxide, as shown at the composition, is the basic component of the mixture, with excellent Fire Resistance results.

The Magnesium Chloride increases the hardness of the mixture after the solidification and improves its resistance in fire, while the water glass acts as the binding mean.

The used Magnesia is coming from baking of magnesite of Evoias or of Vavdou Halkidikis.

The described binding material is particularly appropriate for panels that are constructed with the technique of cold compression.

### PICTURE 1

### Lining Panels of 25 mm

Front side of 2,5 mm composite plate composed of 3 layers glass fibre reinforced board (layers 1-3).

Middle part of 20 mm mineral wool type “Rockwool Fire Slab 160” (layer 4).

Back side of 2,5 mm composite plate, composed of 2 layers glass fibre reinforced board (layer 5-6).

The panel is internal stoned with “Rockwool Marine Slab 200”, embossed in surfaces composition, in a distance of 300 mm from each other.

### PICTURE 2

### Ceiling Panel of 25 mm

Ceiling panel, is made of the same construction layers according to Picture 1. The panels are joined together with a galvanized steel profile (80×20 mm) filled with “Rockwool Marine Slab 160” and screwed on a support galvanized top profile (80×40 mm).

### PICTURE 3

### Lining Panels of 25 mm

The panels are joint together with a separate piece of panel (80×20 mm), consist of “Rockwool Marine Slab 160” covered on both sides with 2,5 mm glass fibre reinforced board.

### PICTURE 4

### Section of Lining Panel 25 mm

25 mm lining panels are installed on board wit a joint galvanized steel profile, 25×25×25×1 mm at the bottom side.

### PICTURE 5 & 6

### Ready Made Corners

Special fabricated panels in various sizes and shapes to be joined with standard lining panels.

### PICTURE 7

### Connection of Wall & Ceiling Panels

To connect the wall and ceiling panels, a galvanized steel profile is used, fitted on the wall panel. The ceiling panel, reinforced with an inner galvanized Steel profile, is screwed at its final position.

### PICTURE 8

### Partition Panels of 50 mm

B-30 class bulkhead of 50 mm thick is made of mineral wool type “Rockwool Fire Slab 110” reinforced along edges with “Rockwool Marine Slab 200”.

The mineral wool is covered on both sides with 2,5 mm composite plate consisted of glass fibre reinforced board (same construction layers as Picture 1).

The panels are joined together with a galvanized steel bar 40×2 mm.

### PICTURE 9

### Partition Panels of 50 mm

The 50 mm partition panel is internal stiffened with “Rockwool Marine Slab 200” embossed in surfaces composition at a distance of 300 mm from each other.

### PICTURE 10

### A-60 Class Single Leaf Hinged Door

The door blade is fabricated with “Rockwool Maine Slab 160” faced on both sides and in middle with 2,5 mm composite plate composed of glass fibre reinforced board.

The leaf is internal stiffened with “Rockwool Marine Slab 200” of width 20 mm, embossed in surfaces composite in a distance of 300 mm from each other.

Inner reinforcement steel edge profile and outer steel edges trim.

Frame of 3 mm “Z” profile in mild steel.

Total door thickness: 46 mm.

### PICTURE 11

### B-30 Class Single Leaf Hinged Door

The blade is fabricated with “Rockwool Marine Slab 160”, faced on both outer sides and in the middle with 2,5 mm composite plate composed of glass fibre reinforced bond.

The leaf is internal stiffened with “Rockwool Marine Slab 200” of width 20 mm, embossed in surfaces composite in a distance of 300 mm from each other.

Inner reinforcement steel edge profile and outer steel edges trim.

Frame from 1,5 mm steel profile.

Total door thickness: 33 mm.

1. The fire-resistant and sound-isolating panels for ships accommodation areas linings whose construction is characterized by the following processes.
Two external layers, at both sides of the sails respectively, each one of them consisted of two layers of glass cloth (2,3 and 5,6 respectively, see FIG. 1), which are connected with a binding material.
An additional layer of glass cloth (1), of lower density than the density of the above, which is fitted on the outside surface of the panel which after the installation, remains visible to the lined area and is connected to the other layers with the same binding material.
An internal layer of insulating material from mineral fiber (4), which is connected to the above surface layers with layers of the same binding material.
Reinforcing elements, that are inserted into the internal layer pieces and connect the two external layers and that consist of the insulating material of a higher density mineral fiber (7), immersed in and enriched with a binding material. In cases where there is no demand of high strict sound-isolation specifications, the reinforcing materials can be replaced by another appropriate material.

2. A binding material, which is mentioned in claim 1 and which is characterized by the following composition:

| Magnesia (Mg.O) | 33,33%, of 91-95% purity. |
|---|---|
| Magnesium Chloride (MgCl₂) | 24,24%, of 47% purity. |
| Sodium Silicate (water glass, SiO₂:Na₂O) | 2,02% |
| Water | 40,40% |

3. The reinforcing material layers for the construction of external layers (2,3/5,6) at the two sides of the panels which is mentioned in claim 1 and which are characterized by the fact that they consist of glass cloth and they are connected to each other and to the internal layer with multiple layers of binding material, which is mentioned in claim 2. At the one of the layers of the sides of the panels, a third layer of lower density glass cloth (1) is fitted, which is connected to the former ones with the same binding material, so that a better surface is obtained, that is a better surface for coloring or covering with a decorative fire-resistant coating on the side that remains visible after the final installation of the panels the respective accommodation area of the ship.

4. The use of reinforcing strips (7), which are characterized by the fact that they consist of a higher density glass fiber, immersed in and enriched with a binding material and are fitted in parallel to the high dimension of the panel and vertically to its surface level, when there is a demand for high sound-isolation specifications. The connection of the insulating material pieces, made of mineral fiber, of the internal layer with the reinforcing strips (7) made of mineral fiber of higher density with the external layers of the sides of the panels (1,2,3 and 5,6) mentioned at the above claims, with multiple layers of binding material mentioned at the above claim 2.

5. The construction method of the panels which is mentioned at the above claims, is characterized by the following processes:
I. A low density external glass cloth (1) (final external surface).
II. Two layers of a higher density glass cloth (2,3)
III. Elements of an internal insulating layer (4) with the insertion of reinforcing strips by mineral fiber (7) of higher strength, immersed in and enriched with the binding material.
IV. Two layers of high density glass cloth (5,6)
V. Multiple layers of binding material among the above layers.
VI. Cold compression (environment temperature).
VII. Construction of the external layers at both sides of the panels, which are mentioned at the above claims, as a complex construction, which consists of glass cloth layers connected to each other with multiple layers of binding material, so that the final product, after the hardening, has the desired strength in extreme strains and at fire and gives the necessary inflexibility to the panel in order to be used where it is intended for.

6. The use of a binding material for the construction of panel as mentioned at the above claims, which is characterized by the composition mentioned at the above claim 2, so that the necessary strength at fire is ensured.

7. The combination of the layers at the sides of the panel, which is mentioned at the above claims, with the internal insulating layer and the insertion of reinforcing strips of higher density, so that the necessary sound-isolation demands are ensured.

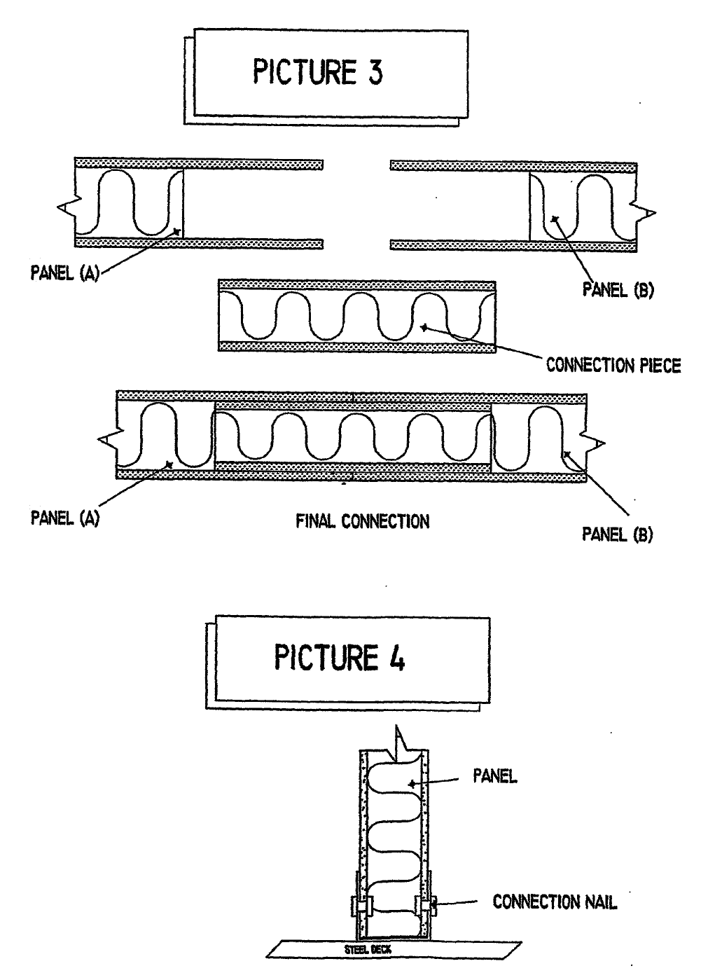

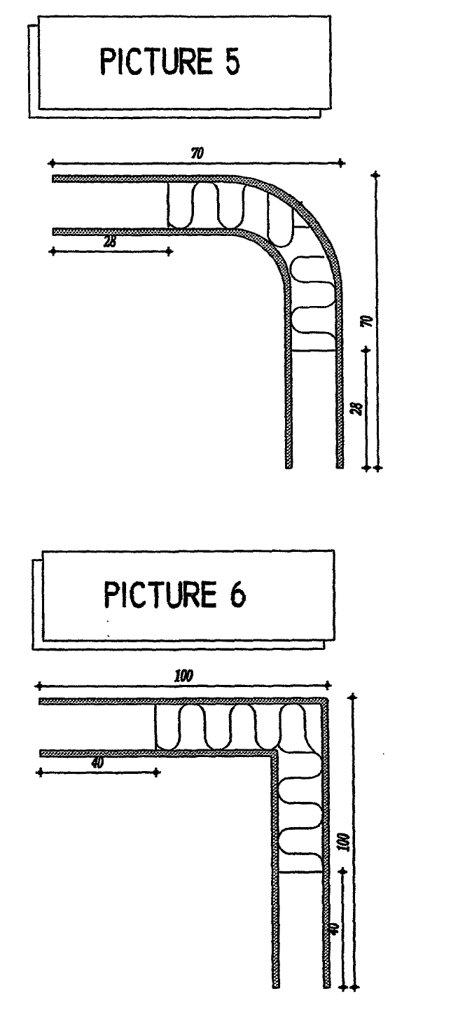

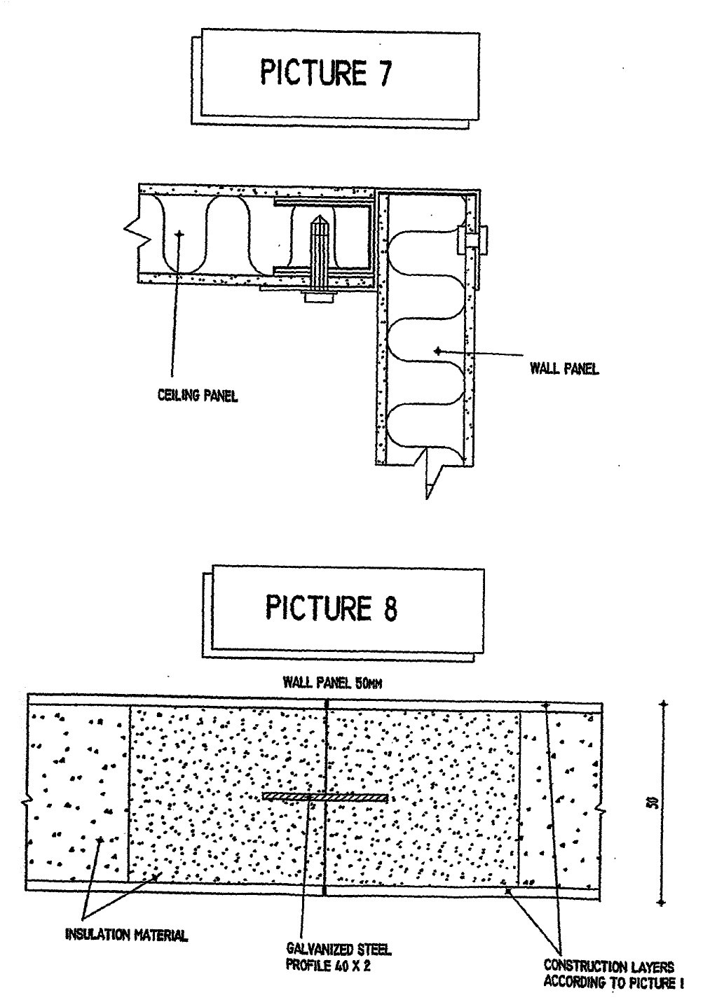

8. The complete system which is characterized by the use of a panel for the construction of lining elements and ceiling, in accommodation areas of ships, with the necessary details for the connection of panels to each other, to the floor area, to the angular elements, as well as the necessary details for the general supports of the panels during their installation on the sip (see (FIGS. 2-7).

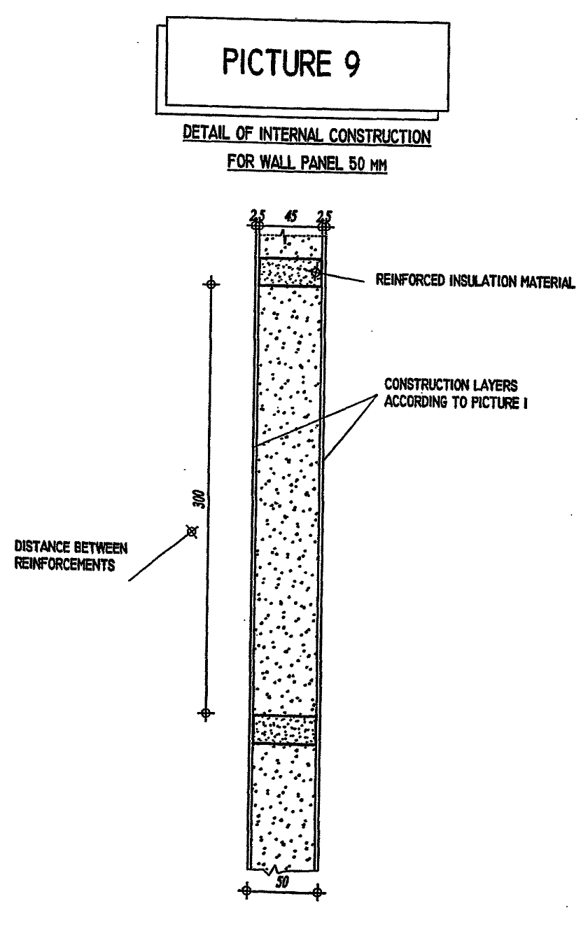

9. A construction of panel of double thickness (50 mm), which are characterized by the use of an internal layer of insulating material of respective thickness, but concerning all the other elements, it is based on the same construction principles of the panels as they are mentioned at the above claims, for the construction of partition walls at ships accommodation areas, as well as the respective details of support and connection of these panels at the areas of their final installation on the ship (see FIGS. 8-9).

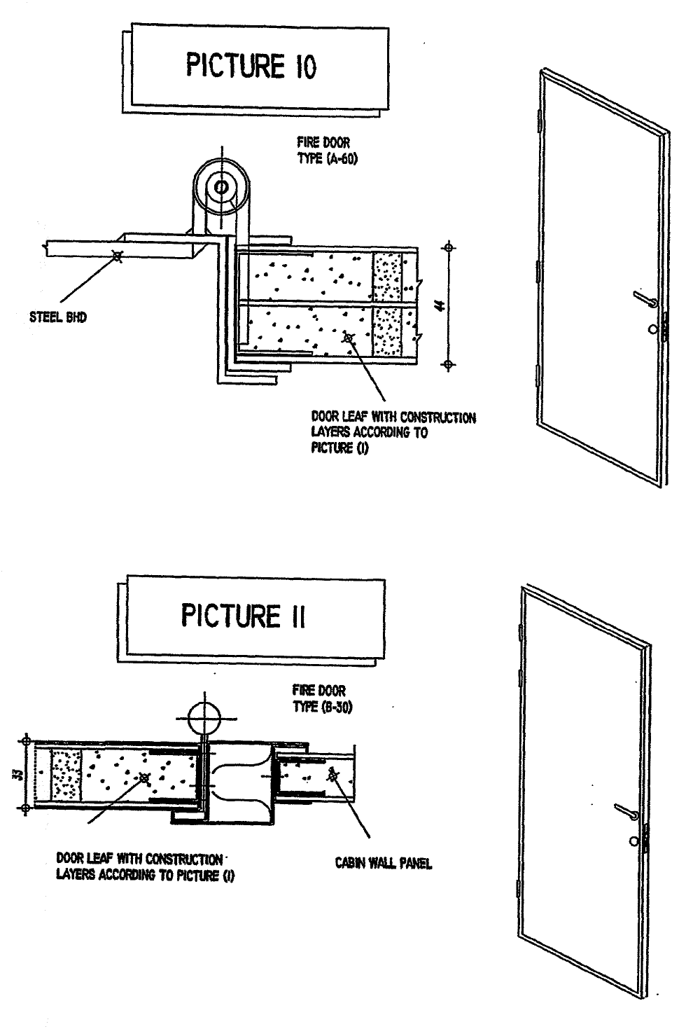

10. A construction of fire-resistant doors, which is characterized by the use of panels of double layering, that consist of three layers of inflexible material (made of glass cloth with binding material, as mentioned at the above claims), two external and one internal, among which two layers of insulating material are inserted, as they are mentioned at the above claims for the construction of a panel of total thickness of 45 mm, appropriate for the construction of fire-resistant doors of type A-60 (60 minutes) and B30 (30 minutes), as well as appropriate details for the doors construction, assembly and installation on the ship (see FIGS. 10-11). The layering of the panels elements for the construction of fire-resistant doors, is as shown at the respective figures, but the composition and the construction procedure of the respective materials remain as they are mentioned for the basic panel with a thickness of 25 mm at the above claims.

11. The use of internal reinforcing elements for the panels, alternative to the strips of high density mineral fiber, using metallic reinforcing or other equivalent materials, when there is no demand of high sound-isolation specifications (see FIG. 12-ELEMENTS 1-7).

12. A complete system, which is characterized by the use of panels and the other derivatives, that are mentioned at the above claims, for the construction of prefabricated or semi-prefabricated ships accommodation cabins, as well as the relative procedures and details of connecting, assembling packaging and suspension for the transportation, so that the high strength at fire is ensured after the installation on the ship.

13. A complete system, which is characterized by the use panels and the other derivatives, that are mentioned at the above claims, for the construction of prefabricated sanitary units (toilets), as well as the relative details of connecting, assembling, packaging and suspension for the transportation to the ship, so that high strength at fire is ensured after the installation on the ship.

14. A complete system, which is characterized by the use panels as well as relative derivatives, that are mentioned at the above claims, for the construction of appropriate openings of fire-protection class B-15 (30 minutes) for connecting Vacuum Toilet Systems.

15. A complete system, which is characterized by the use panels and relative derivatives, that are mentioned at the above claims, for the construction of ceiling's recesses, for the placement of lamps, air condition devises, fire-tracing, inspection gates e.t.c.
